(19) United States
(12) Patent Application Publication
(10) Pub. No.: US 2017/0229824 A1
(43) Pub. Date: Aug. 10, 2017

(54) JUMP WIRE-FREE PATCH BOARD

(71) Applicant: ShenZhen ORICO Technologies Co., Ltd., ShenZhen (CN)

(72) Inventor: Yeyou XU, ShenZhen (CN)

(21) Appl. No.: 15/280,759

(22) Filed: Sep. 29, 2016

(30) Foreign Application Priority Data
Aug. 7, 2015 (CN) 201510483868.6

(51) Int. Cl. H01R 25/00; H01R 13/66; H01R 13/717

(52) U.S. Cl. CPC H01R 25/003; H01R 13/7175; H01R 13/6675

(57) ABSTRACT

The invention is applicable to the technical field of electronics, and provides a jump wire-free patch board comprising a patch board body and a power line. The patch board body comprises at least a switch module, a power supply conversion device, a jack module, an elastic metal sheet assembly and a protection module. All components of the patch board body are integrally packaged on a circuit board, the protection module comprises an overload protection switch and a lightning protection and anti-surge device, the power supply conversion device comprises at least one of a high voltage AC output terminal and/or a low voltage DC output terminal, and the protection module is electrically connected to the high voltage AC output terminal and/or the low voltage DC output terminal through the elastic metal sheet assembly. Whereby, the invention realizes a more safe connection structure without jump wire.

### CROSS-REFERENCE TO RELATED APPLICATIONS

This application claims priority to Chinese Patent Application No. 201510483868.6 filed Aug. 7, 2015, which is incorporated herein by reference in its entirety.

### TECHNICAL FIELD

The invention relates to the technical field of electronics, in particular to a jump wire-free patch board.

### DISCUSSION OF THE RELATED ART

At present, multi-functional power sockets mainly depend on more internal protective actions in use. But with the changes of the market, the safety performance of such products is very important. In order to satisfy the people's attention to and requirements for safety, much safer protection mechanisms play an important role in such power socket products.

Existing patch boards have the function of using child safety doors for jack protection, with single function of modules. Or commercially available products of public mold with safety doors are extensively available in the market. The rear protection behind elastic sheet devices and force control of safety doors are insufficient, and existing multi-functional sockets have poor experience in this regard.

To sum up, the prior art has obvious inconvenience and defects in actual use, therefore, it is necessary to make improvement.

### SUMMARY OF THE INVENTION

With regard to the defects, the invention aims at providing a jump wire-free patch board to address rear protection of elastic sheet devices of AC patch boards, and keep robustness of elastic sheets and effective force control of safety doors when the elastic sheets are under large force.

In order to realize the purpose, the invention provides a jump wire-free patch board comprising a patch board body and a power line, the patch board body comprises at least a switch module, a power supply conversion device, a jack module, an elastic metal sheet assembly and a protection module, and all components of the patch board body are integrally packaged on a circuit board;

the protection module comprises an overload protection switch and a lightning protection and anti-surge device, the power supply conversion device comprises at least one of a high voltage AC output terminal and/or a low voltage DC output terminal, and the protection module is electrically connected to the high voltage AC output terminal and/or the low voltage DC output terminal through the elastic metal sheet assembly.

According to the patch board of the invention, the patch board further comprises an LED indicator, the LED indicator is electrically connected with the power supply conversion device, the jack module is arranged in the patch board body, and the elastic metal sheet assembly is fixed on the jack module; the jack module comprises a safety door assembly, an elastic sheet fixing assembly and a rear cover assembly, the elastic sheet fixing assembly is integrated, and the high voltage AC output terminal and/or the low voltage DC output terminal matches the position of the elastic metal sheet assembly; three contacts for a neutral wire, a live wire and an earth wire provided at the front end of the elastic metal sheet assembly are used for connecting the power line, and other three contacts for a neutral wire, a live wire and an earth wire provided at the rear end of the elastic metal sheet assembly are connected with the electric equipments; and the switch module, the protection module and the low voltage DC output terminal are welded on the circuit board.

According to the patch board of the invention, the elastic sheet fixing assembly is detachably connected in the patch board, the safety door assembly is moveably connected with the elastic sheet fixing assembly through an elastic member, the rear cover assembly is detachably connected at the bottom of the elastic sheet fixing assembly, and the safety door assembly, the elastic sheet fixing assembly and the rear cover assembly are standard module assemblies.

According to the patch board of the invention, the jack module and the elastic metal sheet assembly are combined in the patch board, the elastic metal sheet assembly comprises at least three metal contact sheets, the metal contact sheets are correspondingly arranged in the elastic sheet fixing assembly, the metal contact sheets are welded and fixed on the circuit board when the ends of each of the metal contact sheets are clamped in a matching hole of the circuit board.

According to the patch board of the invention, the metal contact sheets having raised plates of metal contact surface structure, arc structures are arranged on two sides of each of the plates, the two arc structures get together toward the center, and the metal contact sheets are arranged into a group of three wires consisting of a live wire, a neutral wire and an earth wire at a constant spacing.

According to the patch board of the invention, the protection module further comprises a current filter and a voltage regulator, the current filter is connected with the overload protection switch and the lightning protection and anti-surge device, and connects the elastic metal sheet assembly; the power supply conversion device comprises a high voltage AC submodule, a low voltage DC submodule and a power input terminal, the power supply conversion device is connected with a grid through the power input terminal, and connected with the devices which need to use power supply through the high voltage AC output terminal and the low voltage DC output terminal, and the high voltage AC submodule is electrically connected with the low voltage DC submodule.

According to the patch board of the invention, high voltage AC is output to the high voltage AC output terminal and the low voltage DC submodule respectively after AC is treated through the high voltage AC submodule, and the low voltage DC submodule rectifies and transforms the received high voltage AC signal, and outputs low voltage DC to the low voltage DC output terminal.

According to the patch board of the invention, the power line is high voltage wire, the power line is provided with a terminal, and the terminal is fixedly welded on a terminal hole of the circuit board, and electrically connected with the power input terminal.

According to the patch board of the invention, an isolated plastic area is provided at an opening in an enclosure of the patch board to block the protection module from the high voltage AC output terminal, and block the high voltage AC output terminal from the low voltage DC output terminal.

According to the patch board of the invention, the low voltage DC output terminal is a USB interface, and the high voltage AC output terminal comprises a three-pin socket and/or a two-pin socket.

The invention realizes a connection structure without jump wire mainly based on the modular design principle, multiple connection methods and processes. The printed circuit board assembly (PCBA) provides a much safer and comprehensive protective measure for extensive isolation protection.

### BRIEF DESCRIPTION OF THE DRAWINGS

FIG. 1 is a schematic circuit diagram of a jump wire-free patch board of the invention.

FIG. 2 is a schematic circuit diagram of a preferred embodiment of the jump wire-free patch board of the invention.

FIG. 3 is a schematic stereoscopic diagram of the jump wire-free patch board of the invention.

FIG. 4 is an exploded stereogram of a jack module of the jump wire-free patch board of the invention.

FIG. 5 is an exploded stereogram of an embodiment of the jump wire-free patch board of the invention.

FIG. 6 is an enlarged view of a protection module of the jump wire-free patch board of the invention.

FIG. 7 is an enlarged view of a protection module of the jump wire-free patch board of the invention.

FIG. 8 is an enlarged view of an elastic metal sheet assembly of the jump wire-free patch board of the invention.

### DESCRIPTION OF PREFERRED EMBODIMENTS

In order to make the purpose, technical solution and advantages of the invention more clear, the invention will be described in detail in combination with accompanied drawings and embodiments. It should be understood that various embodiments described herein are only used to explain the invention rather than defining the invention.

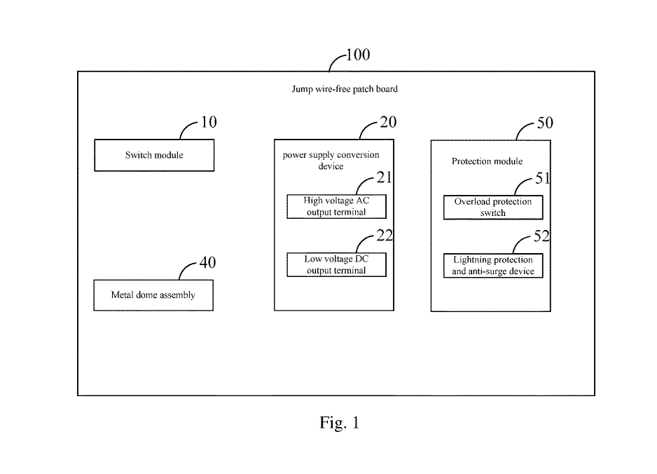

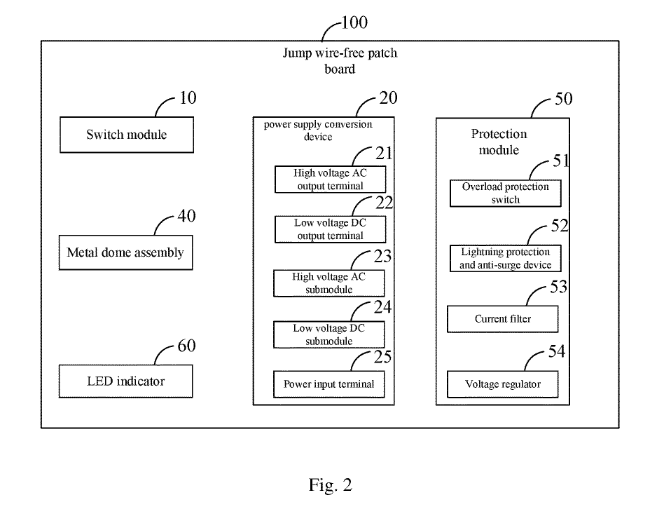

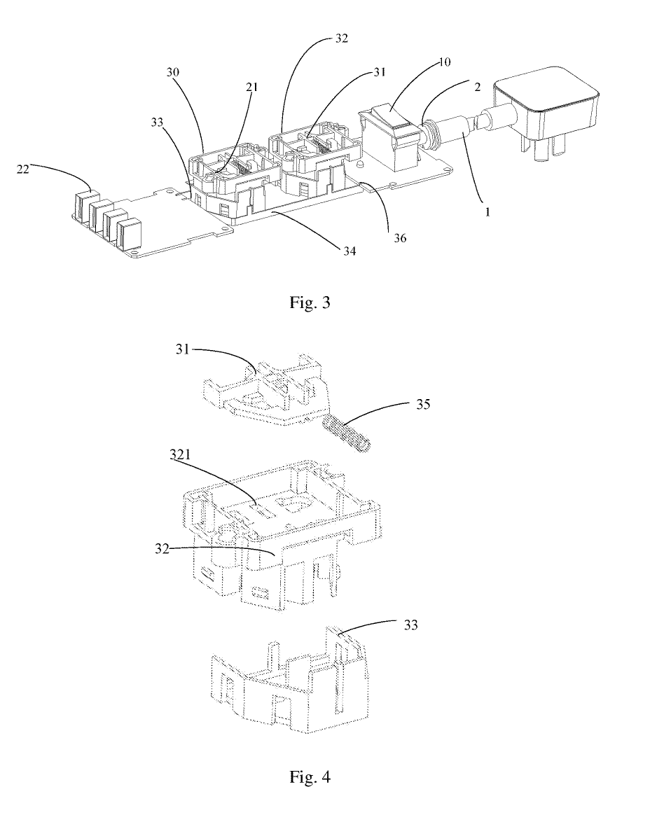

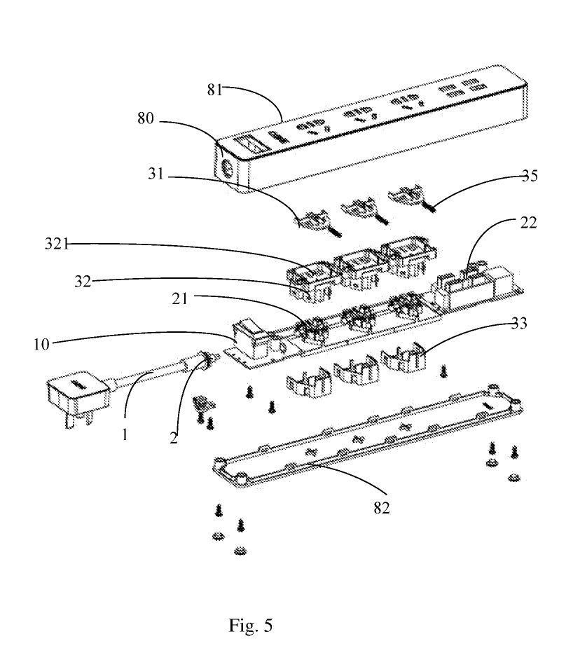

In order to realize the purpose, an explanation is made in combination with drawings, as shown in FIG. 1 to FIG. 3, the invention provides a jump wire-free patch board comprising a patch board body and a power line 1, the patch board body comprises at least a switch module 10, a power supply conversion device 20, a jack module 30, an elastic metal sheet assembly 34 and a protection module 50, and all components of the patch board body are integrally packaged on a circuit board;

the protection module 50 comprises an overload protection switch 51 and a lightning protection and anti-surge device 52, the power supply conversion device 20 comprises at least one of a high voltage AC output terminal 21 and/or a low voltage DC output terminal 22, and the protection module 50 is electrically connected to the high voltage AC output terminal 21 and/or the low voltage DC output terminal 22 through the elastic metal sheet assembly 34; and the switch module 10, the protection module 50 and the low voltage DC output terminal 22 are welded on the circuit board. Specifically, when it is necessary to fix all components on the patch board body at the melt positions of a hot melt machine through a modular mechanism of a mold, 2 hot melt irons make up a group of hot melt fixing molds, and the hot melt irons are respectively clamped at corresponding positions. A product is underlaid, the hot melt irons are molten at high temperature of the mold by using the hot melt machine, and molded after cooling, thus fixing the product to corresponding internal parts to make up a PCBA.

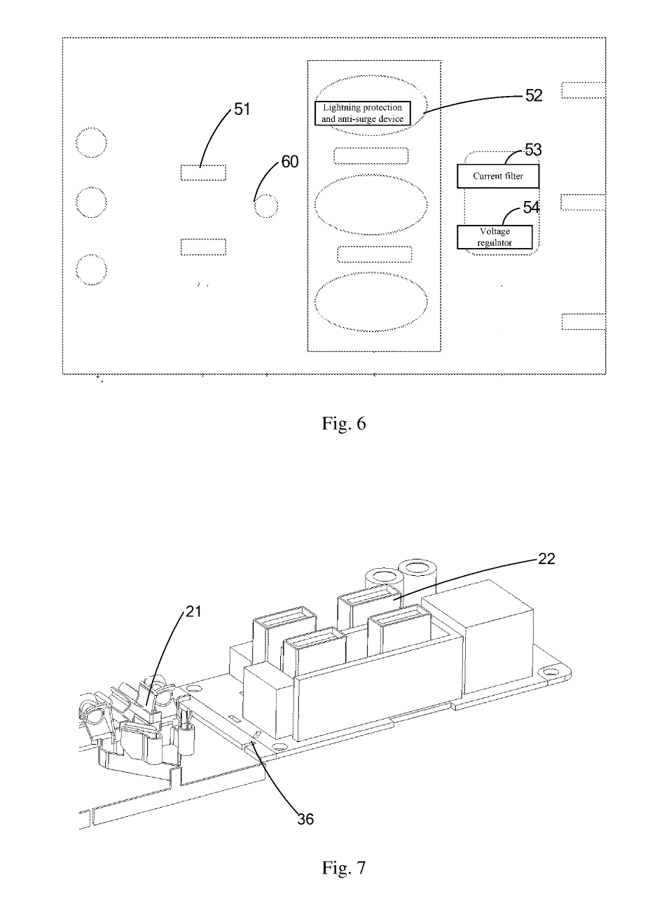

Further, the patch board 100 further comprises an LED indicator 60, the LED indicator 60 is electrically connected with the power supply conversion device 20, the jack module 30 is arranged in the patch board body, and the elastic metal sheet assembly 34 is fixed on the jack module 30; the jack module 30 comprises a safety door assembly 31, an elastic sheet fixing assembly 32 and a rear cover assembly 33, the elastic sheet fixing assembly 32 is integrally formed, and the high voltage AC output terminal 21 and/or the low voltage DC output terminal 22 matches the position of the elastic metal sheet assembly 34; three contacts for a neutral wire 342, a live wire 341 and an earth wire 343 provided at the front end of the elastic metal sheet assembly 34 are used for connecting the power line 1, and other three contacts for a neutral wire 342, a live wire 341 and an earth wire 343 provided at the rear end of the elastic metal sheet assembly 34 are connected with the electric equipments. The three contacts for a neutral wire, a live wire and an earth wire provided at the front end of the patch board body are used for connecting the power line. The overload protection switch, the LED indicator 60 and the lightning protection and anti-surge device 52 are successively welded at welding points of the switch module 10, as shown in FIG. 6. After power on, the LED indicator 60 indicates the power-on state. The beautiful appearance of products and light softness of the LED indicator 60 may be too bright and dazzling in multiple components and parts. The LED indicator 60 can be concealed by changing the depth of the LED indicator structure. The LED indicator is arranged in the middle of the enclosure structure of the product, a corresponding lamp pole is provided for the lightning protection and anti-surge device 52, and transmittance of light is controlled by the depth of the mold in the lamp pole. Extended edges of the lamp pole cover the periphery of the LED indicator 60 to prevent light transmission from the edges.

In the embodiment, the elastic sheet fixing assembly 32 is detachably connected in the patch board 100, the safety door assembly 31 is moveably connected with the elastic sheet fixing assembly 32 through an elastic member 35, the rear cover assembly 33 is detachably connected at the bottom of the elastic sheet fixing assembly 32, and the safety door assembly 31, the elastic sheet fixing assembly 32 and the rear cover assembly 33 are standard module assemblies.

Preferably, the jack module 30 and the elastic metal sheet assembly 34 are combined in the patch board 100, the elastic metal sheet assembly 34 comprises at least three metal contact sheets, the metal contact sheets are correspondingly arranged in the elastic sheet fixing assembly 32, the metal contact sheets are welded and fixed on the circuit board when the ends of each of the metal contact sheets are clamped in a matching hole 36 of the circuit board. Components and parts can be more easily integrated by means of a PCBA.

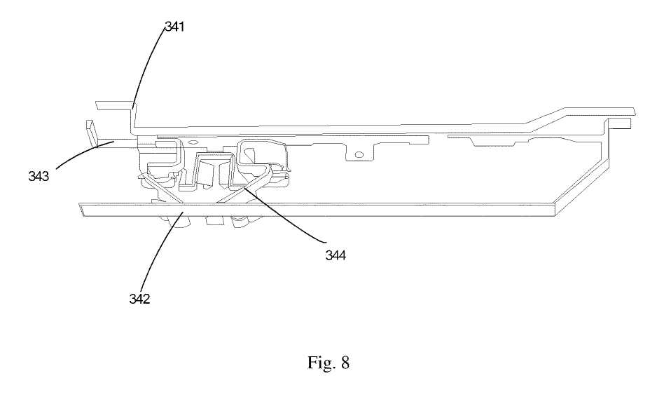

As shown in FIG. 8, the metal contact sheets have raised plates of metal contact surface structure, arc structures 344 are arranged on two sides of each of the plates, the two arc structures 344 get together toward the center, the metal contact sheets are arranged into a group of three wires consisting of a live wire 341, a neutral wire 342 and an earth wire 343 at a constant spacing for connecting the plug of the devices which need to use power supply, and the two arc structures 344 hold pins of the plug, as shown in FIG. 7.

The protection module 50 further comprises a current filter 53 and a voltage regulator 54, the current filter 53 is connected with the overload protection switch 51 and the lightning protection and anti-surge device 52, and connects the elastic metal sheet assembly 34; the power supply conversion device 20 comprises a high voltage AC submodule 23, a low voltage DC submodule 24 and a power input terminal 25, the power supply conversion device 20 is connected with a grid through the power input terminal 25, and connected with the devices which need to use power supply through the high voltage AC output terminal 21 and the low voltage DC output terminal 22, and the high voltage AC submodule 23 is electrically connected with the low voltage DC submodule 24.

Further, high voltage AC is output to the high voltage AC output terminal 21 and the low voltage DC submodule 24 respectively after AC is treated through the high voltage AC submodule 23, and the low voltage DC submodule 24 rectifies and transforms the received high voltage AC signal, and outputs low voltage DC to the low voltage DC output terminal 22. The power supply conversion device can realize simultaneous high voltage AC and low voltage DC output to meet the demands of different devices which need to use power supply without connecting to other power adapters. In addition, the integrated structure of the power supply conversion device simplifies the line connection, thus effectively avoiding safety incidences due to complex line connection.

The power line 1 is high voltage wire, the power line is provided with a terminal, the terminal is fixedly welded on a terminal hole of the circuit board, and the terminal 2 is electrically connected with the power input terminal 25.

Preferably, an isolated plastic area is reserved at a hole 36 in an enclosure 80 of the patch board 100 to block the protection module from the high voltage AC output terminal, and block the high voltage AC output terminal from the low voltage DC output terminal. The interior structure of the enclosure 80 of the patch board 100 can be seen when an upper enclosure 81 and a lower enclosure 82 are open. As plastic has insulating effect, an insulating block structure reserved at the opening 36 can fix the PCBA, and develop the most suitable insulating block function to completely isolate electronic components and parts through the structure. The PCBA allows high voltage and low voltage circuits to connect with the elastic metal sheet assembly 34 through a reserved isolating hole at a reserved isolation spacing. For example, at the hole 36 as shown in FIG. 7, the elastic metal sheet assembly 34 is only allowed to pass through the hole 36, and plastic area can be arranged for isolation. An isolating plastic area is reserved at the hole 36 according to the isolation spacing on the PCBA. The PCBA is arranged in the patch board body, and then the PCBA is stabilized in the product through the isolating plastic area. After the PCBA is arranged in the isolating plastic areas, components and parts are effectively isolated naturally, and high voltage and low voltage areas also have isolation effect.

Further, fixing structures are provided respectively on both sides of the elastic sheet fixing assembly 32, and the elastic sheet fixing assembly 32 is detachably connected in the body 20 of the patch board 100 through the fixing structures. The elastic member 35 is a spring, and the elastic sheet fixing assembly 32 adjusts tightness against the safety door assembly 31 through the spring. On the jump wire-free patch board 30, multiple elastic sheet fixing structures used for fixing the metal contact sheets 34 are arranged on the elastic sheet fixing assembly 32. Each elastic metal sheet can extend downward or upward at a constant spacing, and a group of elastic metal sheets at the same spacing form an elastic metal sheet assembly of the patch board 100 that can extend upward or downward infinitely, so that multiple jack modules 30 can be adopted in the high voltage AC output terminal 21, realizing extension and expansion of the patch board 100.

The hole 36 of the corresponding size of each elastic metal sheet is drilled on the PCBA, and connection of the circuit is arranged in the hole. The elastic metal sheet is aligned with the hole on the PCBA, then clamped in the matching hole 36, and welded to prevent the circuit from spark.

Preferably, the enclosure 80 is a plastic enclosure. The elastic sheet fixing assembly 32 adjusts tightness against the enclosure 80 through the metal contact sheets 34. When the plug is inserted in a throughhole 321, the elastic member 35 drives the safety door assembly 31 to contract. The elastic member 35 is a spring.

Each of the metal contact sheets 34 has an outer insulating layer. The elastic sheet fixing assembly 32 is fixed with the patch board body, then modularly arranged in the enclosure and fixed together with the rear cover assembly 33 to better protect the fixing mechanism of the metal contact sheets 34, and avoid the jack module 30 on the high voltage AC output terminal 21 loosening in the patch board body, allowing the patch board to be more robust. In addition, insulation around the metal contact sheets 34 can be made better and refined through the rear cover assembly 33. The patch board body is provided with the high voltage AC output terminal 21 and the low voltage DC output terminal 22. In the embodiment, the low voltage DC output terminal 22 is a USB interface.

To sum up, the jump wire-free patch board integrates multiple functions and improves functional composition of parts mainly based on the modular design principle. The jump wire-free patch board can be evolved into a multi-functional standard assembly, and can realize better universality in multiple products. Multi-functional assemblies thereof avoid the risk of jump wire welding of products, and the jump wire-free design can avoid such situations as current spark. The development of standard assemblies improves the appearance of products and effectively adjust the sizes of products with refined parts.

Of course, the invention may have other embodiments. Those skilled in the art can make various corresponding changes and modifications according to the invention without departing from the spirit and essence of the invention, but such changes and modifications should be incorporated in the protection scope of the appended claims of the invention.

What is claimed is:

1. A jump wire-free patch board, comprising a patch board body and a power line, and characterized in that the patch board body comprises at least a switch module, a power supply conversion device, a jack module, an elastic metal sheet assembly and a protection module, and all components of the patch board body are integrally packaged on a circuit board;
the protection module comprises an overload protection switch and a lightning protection and anti-surge device, the power supply conversion device comprises at least one of a high voltage AC output terminal and/or a low voltage DC output terminal, and the protection module is electrically connected to the high voltage AC output terminal and/or the low voltage DC output terminal through the elastic metal sheet assembly.

2. The patch board according to claim 1, characterized by further comprising an LED indicator, the LED indicator being electrically connected with the power supply conversion device, the jack module being arranged in the patch board body, and the elastic metal sheet assembly being fixed on the jack module; the jack module comprising a safety door assembly, an elastic sheet fixing assembly and a rear cover assembly, the elastic sheet fixing assembly being integrally formed, and the high voltage AC output terminal and/or the low voltage DC output terminal matching the position of the elastic metal sheet assembly; three contacts for a neutral wire, a live wire and an earth wire provided at the front end of the elastic metal sheet assembly being used for connecting the power supply conversion device, and other three contacts for a neutral wire, a live wire and an earth wire provided at the rear end of the elastic metal sheet assembly being connected with the electric equipments; and the switch module, the protection module and the low voltage DC output terminal being welded on the circuit board.

3. The patch board according to claim 2, characterized in that the elastic sheet fixing assembly is detachably connected in the patch board, the safety door assembly is moveably connected with the elastic sheet fixing assembly through an elastic member, the rear cover assembly is detachably connected at the bottom of the elastic sheet fixing assembly, and the safety door assembly, the elastic sheet fixing assembly and the rear cover assembly are standard module assemblies.

4. The patch board according to claim 3, characterized in that the jack module and the elastic metal sheet assembly are combined in the patch board, the elastic metal sheet assembly comprises at least three metal contact sheets, the metal contact sheets are correspondingly arranged in the elastic sheet fixing assembly, the metal contact sheets are welded and fixed on the circuit board when the ends of each of the metal contact sheets are clamped in a matching hole of the circuit board.

5. The patch board according to claim 4, characterized in that the metal contact sheets having raised plates of metal contact surface structure, arc structures are arranged on two sides of each of the plates, the two arc structures get together toward the center, and the metal contact sheets are arranged into a group of three wires consisting of a live wire, a neutral wire and an earth wire at a constant spacing.

6. The patch board according to claim 2, characterized in that the protection module further comprises a current filter and a voltage regulator, the current filter is connected with the overload protection switch and the lightning protection and anti-surge device, and connects the elastic metal sheet assembly; the power supply conversion device comprises a high voltage AC submodule, a low voltage DC submodule and a power input terminal, the power supply conversion device is connected with a grid through the power input terminal, and connected with the electric equipments through the high voltage AC output terminal and the low voltage DC output terminal, and the high voltage AC submodule is electrically connected with the low voltage DC submodule.

7. The patch board according to claim 6, characterized in that high voltage AC is output to the high voltage AC output terminal and the low voltage DC submodule respectively after AC is treated through the high voltage AC submodule, and the low voltage DC submodule rectifies and transforms the received high voltage AC signal, and outputs low voltage DC to the low voltage DC output terminal.

8. The patch board according to claim 2, characterized in that the power line is high voltage wire, the power line is provided with a terminal, and the terminal is fixedly welded on a terminal hole of the circuit board, and electrically connected with the power input terminal.

9. The patch board according to claim 1, characterized in that an isolated plastic area is provided at an opening in an enclosure of the patch board to block the protection module from the high voltage AC output terminal, and block the high voltage AC output terminal from the low voltage DC output terminal.

10. The patch board according to claim 1, characterized in that the low voltage DC output terminal is a USB interface, and the high voltage AC output terminal comprises a three-pin socket and/or a two-pin socket.
